(19) United States
(12) Patent Application Publication
(10) Pub. No.: US 2018/0313670 A1
(43) Pub. Date: Nov. 1, 2018

(54) MAGNETISM-DETECTING DEVICE AND MOVING-BODY-DETECTING DEVICE

(71) Applicant: TDK Corporation, Tokyo (JP)

(72) Inventor: Kei TANABE, Tokyo (JP)

(73) Assignee: TDK Corporation, Tokyo (JP)

(21) Appl. No.: 15/770,797

(22) PCT Filed: Oct. 5, 2016
(86) PCT No.: PCT/JP2016/079686

§ 371 Date: Apr. 25, 2018

(30) Foreign Application Priority Data
Oct. 29, 2015 (JP) 2015-212440

(51) Int. Cl. G01D 5/245

(52) U.S. Cl. CPC G01D 5/245

(57) ABSTRACT

A magnetism-detecting device and a moving-body-detecting device, capable of detecting a movement of a moving body that is not a magnetic body. The moving-body-detecting device includes the magnetism-detecting device and a rotating body that moves with respect to the magnetism-detecting device. The magnetism-detecting device has a coil for generating an alternating magnetic field and a magnetic sensor to which the magnetic field generated by the coil is applied. The rotation of the rotating body changes the magnetic field applied to the magnetic sensor. An output signal from the magnetic sensor is synchronously detected using a signal that is supplied to the coil in order to generate the alternating magnetic field.

### TECHNICAL FIELD

The present invention relates to a magnetism-detecting device that detects a magnetic field change caused by relative movement of a moving body, and to a moving-body-detecting device including the same.

### BACKGROUND ART

A magnetism-detecting device has hitherto been used for position detection (rotation detection) of a moving body such as a soft magnetic body gear. The following patent document 1 discloses a magnetism-detecting device that detects a rotational speed or a rotation angle of a magnetized rotor having N and S poles arranged alternately on its outer peripheral surface, and the magnetism-detecting device is configured to detect the magnetic field generated by the magnetized rotor by use of two magnetoresistive elements arranged spaced apart from the outer peripheral surface of the magnetized rotor. The following patent document 2 discloses a rotation-detecting device for detecting the rotational state of a teeth-wheel -shaped gear, and the rotation-detecting device is configured to generate a bias magnetic field toward the gear by an electromagnet, so that a change in the bias magnetic field caused by rotations of the teeth of the gear is converted by a magnetic element into an electric signal.

### PRIOR ART DOCUMENT

### Patent Document

Patent Document 1: Japanese Laid-Open Patent Publication No. 2015-87137
Patent Document 2: Japanese Laid-Open Patent Publication No. 2003-287439

### SUMMARY OF THE INVENTION

### Problem to Be Solved by the Invention

The conventional magnetism-detecting device premises that a detection object is a magnetic body and therefore, if the detection object is a non-magnetic body made of copper, aluminum, etc. cannot detect a movement thereof

The present invention was conceived through recognition of such a situation, and an object thereof is to provide a magnetism-detecting device and a moving-body-detecting device, capable of detecting a movement of a moving body that is not a magnetic body.

### Means For Solving Problem

An aspect of the present invention is a magnetism-detecting device that detects a magnetic field change with relative movement of a moving body, comprises:

a magnetic field generating conductor;

a signal applying unit that supplies a signal for generating an alternating magnetic field to the magnetic field generating conductor; and

a magnetic sensor to which a magnetic field generated by the magnetic field generating conductor is applied.

The magnetic field generating conductor may be a coil.

The magnetism-detecting device may comprise:

a synchronous detection unit that synchronously detects an output signal from the magnetic sensor using the signal from the signal applying unit.

Another aspect of the present invention is a moving-body-detecting device comprises:

a magnetism-detecting device; and

a moving body that moves relatively with respect to the magnetism-detecting device,

the magnetism-detecting device comprising:

a magnetic field generating conductor;

a signal applying unit that supplies a signal for generating an alternating magnetic field to the magnetic field generating conductor; and

a magnetic sensor to which a magnetic field generated by the magnetic field generating conductor is applied.

The moving body may include a first and a second part each having conductivity or magnetic permeability different from the other, so that conductivity or magnetic permeability of a portion confronting the magnetism-detecting device varies with relative movement of the moving body.

A frequency of the signal from the signal applying unit may be equal to or greater than a variation frequency of conductivity or magnetic permeability of a portion of the moving body confronting the magnetism-detecting device.

The moving body may include at least one convex part or concave part, so that facing distance from the magnetism-detecting device varies in accordance with relative movement of the moving body.

A frequency of the signal from the signal applying unit may be equal to or greater than a variation frequency of facing distance between the moving body and the magnetism-detecting device.

The magnetic field generating conductor may be a coil circling around the magnetic sensor.

The magnetism-detecting device may comprise a synchronous detection unit that synchronously detects an output signal from the magnetic sensor using the signal from the signal applying unit.

The other aspect of the present invention is a moving-body-detecting device comprises:

a magnetism-detecting device; and

a moving body that moves relatively with respect to the magnetism-detecting device,

the magnetism-detecting device comprising:

magnetic field generating means; and

a magnetic sensor to which a magnetic field generated by the magnetic field generating means is applied,

an eddy current occurring in the moving body with relative movement of the moving body, the magnetic sensor detecting a magnetic field change caused by a change of the eddy current.

The moving body may be a rotating body and the relative movement is a rotational movement.

The moving body may be a rectilinearly moving body and the relative movement is a rectilinear movement.

It is to be noted that any arbitrary combination of the above-described structural components as well as the expressions according to the present invention changed among a system and so forth are all effective as and encompassed by the present aspects.

### Effect of the Invention

According to the present invention, there can be provided a magnetism-detecting device and a moving-body-detecting device, capable of detecting a movement of a moving body that is not a magnetic body.

### BRIEF DESCRIPTION OF DRAWINGS

FIG. 1 is a schematic perspective view of a moving-body-detecting device 1 according to a first embodiment of the present invention;

FIG. 2 is a front sectional view of a magnetism-detecting device 10 of FIG. 1;

FIG. 3 is a plan view of the magnetism-detecting device 10;

FIG. 4 is an explanatory view of a detection principle in the moving-body-detecting device 1 in a case where a rotating body 20 as a detection object has conductivity (Part 1);

FIG. 5 is an explanatory view of the detection principle (Part 2);

FIG. 6 is a circuit diagram of the magnetism-detecting device 10;

FIG. 7 is a schematic perspective view of a moving-body-detecting device 2 according to a second embodiment of the present invention;

FIG. 8 is a schematic perspective view of a moving-body-detecting device 3 according to a third embodiment of the present invention;

FIG. 9 is a schematic perspective view of a moving-body-detecting device 4 according to a fourth embodiment of the present invention;

FIG. 10 is a schematic perspective view of a moving-body-detecting device 5 according to a fifth embodiment of the present invention;

FIG. 11 is a schematic perspective view of a moving-body-detecting device 6 according to a sixth embodiment of the present invention; and

FIG. 12 is a schematic perspective view of a moving-body-detecting device 7 according to a seventh embodiment of the present invention.

### EMBODIMENT FOR CARRYING OUT THE INVENTION

Preferred embodiments of the present invention will now be described in detail with reference to the drawings. The same or equivalent constituent parts, members, etc., shown in the drawings are designated by the same reference numerals and will not be repeatedly described as appropriate. The embodiments are not intended to limit the invention but are mere exemplifications, and all features or combinations thereof described in the embodiments do not necessarily represent the intrinsic natures of the invention.

### First Embodiment

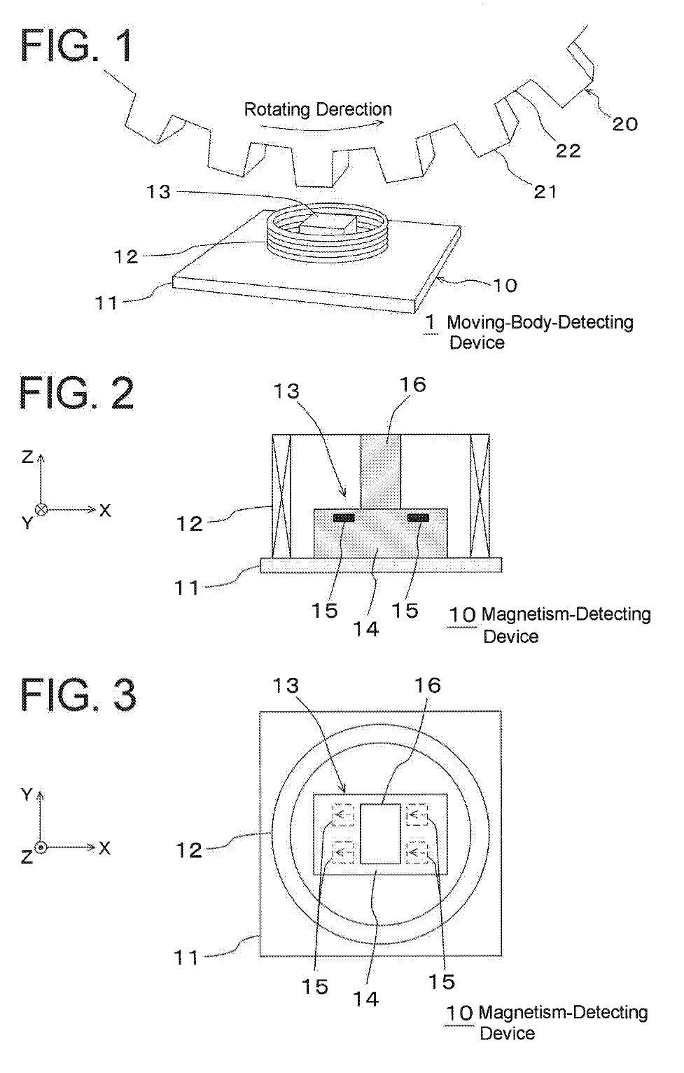

Referring to FIGS. 1 to 6, a first embodiment of the present invention will be described. Three orthogonal axes, i.e. X, Y, Z are defined as shown FIGS. 2 to 5. As shown FIG. 1, a moving body-detecting device 1 of this embodiment has a magnetism-detecting device 10 and a rotating body 20 acting as a moving body. The magnetism-detecting device 10 is disposed at a position confronting an outer peripheral surface (outer periphery) of the rotating body 20 and radially outside of the rotating body 20, to detect a magnetic field change caused by rotations of the rotating body 20. The rotating body 20 is of a teeth wheel gear shape and has on its outer peripheral surface (outer periphery) a convex part 21 as a first portion and a concave part 22 as a second portion. In this embodiment, the convex part 21 and the concave part 22 are alternately arranged at the same pitch on the outer peripheral surface of the rotating body 20 along the entire circumference thereof The rotating body 20 may be a soft magnetic body or may have conductive performance (preferably, made of a metal or a conductor). Detection principles in the respective cases will be described later.

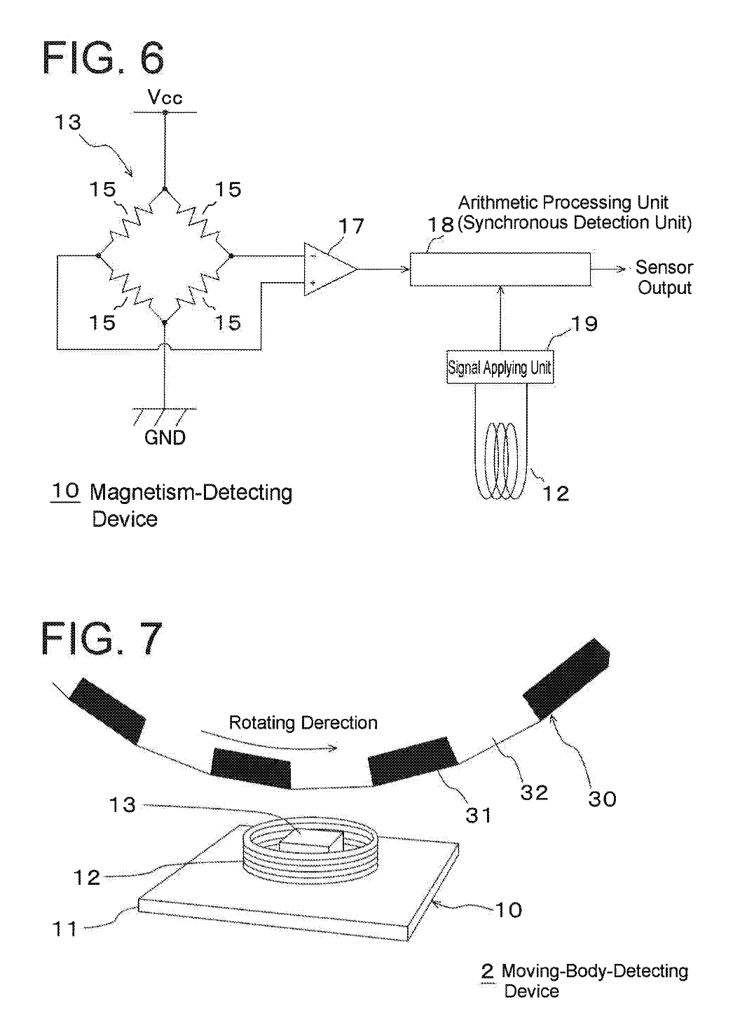

As shown in FIGS. 2 and 3, the magnetism-detecting device 10 has a substrate 11, a coil 12 acting as a magnetic field generating conductor, and a magnetic sensor 13. The coil 12 is disposed (fixed) on the substrate 11 and helically circling around the magnetic sensor 13. The axial direction of the coil 12 is preferably perpendicular to the axial direction of the rotating body 20. In response to a signal supplied from a signal applying unit 19 that will be described later, the coil 12 generates an alternating magnetic field toward the rotating body 20. A magnetic field generated by the coil 12 and changed in accordance with rotations of the rotating body 20 is applied to the magnetic sensor 13. The magnetic sensor 13 has a magnetically sensitive element chip 14 and a soft magnetic body 16. The magnetically sensitive element chip 14 is disposed (fixed) on the substrate 11, while the soft magnetic body 16 is disposed (fixed) on top of the magnetically sensitive element chip 14. The magnetically sensitive element chip 14 has a predetermined number of (four in this case) giant magneto resistive effect (GMR) elements 15 acting as magnetically sensitive elements. As shown in FIG. 3, the GMR elements 15 are arranged separately on both sides of X direction, with the soft magnetic body 16 (the center axis of the coil 12) interposed therebetween. In FIG. 3, arrows within the GMR elements 15 indicate the directions of pinned layer (fixed layer) magnetization of the GMR elements, and the pinned layer magnetization directions of all the GMR elements 15 are −X direction. As shown in FIG. 6, the GMR elements 15 are connected in full bridge. The soft magnetic body 16 lies on a center axis portion of the coil 12 and has a function to strengthen magnetic field components in predetermined directions (in this case, in X and Y directions at the positions of the GMR elements 15) contributable to outputs (resistance changes) of the GMR elements 15.

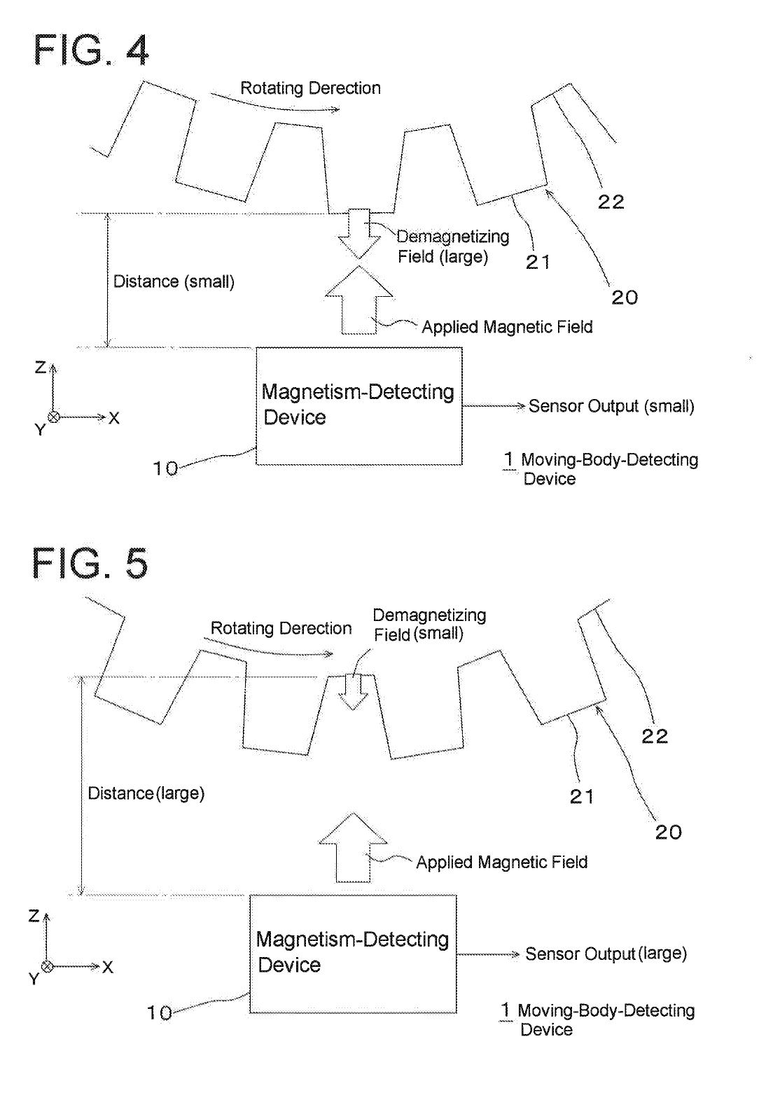

As shown in FIGS. 4 and 5, the rotating body 20 has a facing distance between the rotating body 20 and the magnetism-detecting device 10 that varies depending on the relative movement thereof Specifically, when the convex part 21 of the rotating body 20 faces the magnetism-detecting device 10 as shown in FIG. 4, the facing distance between the rotating body 20 and the magnetism-detecting device 10 becomes small (close), whereas when the concave part 22 of the rotating body 20 faces the magnetism-detecting device 10 as shown in FIG. 5, the facing distance between the rotating body 20 and the magnetism-detecting device 10 becomes large (far).

FIGS. 4 and 5 show the detection principle in the case where the rotating body 20 has conductive performance. When the convex part 21 of the rotating body 20 faces the magnetism-detecting device 10 as shown in FIG. 4, a relative large eddy current occurs in the convex part 21 located in straight front of the magnetism-detecting device 10 and a relative large demagnetizing field is fed back to the GMR elements 15 of the magnetism-detecting device 10, so that the sensor output obtained by a synchronous detection described later becomes relatively small. On the other hand, when the concave part 22 of the rotating body 20 faces the magnetism-detecting device 10 as shown in FIG. 5, a relative small eddy current occurs in the concave part 22 located in straight front of the magnetism-detecting device 10 and a relative small demagnetizing field is fed back to the GMR elements 15 of the magnetism-detecting device 10, so that the sensor output obtained by the synchronous detection described later becomes relatively large.

Although not shown, in the case where the rotating body 20 is the soft magnetic body, when the convex part 21 of the rotating body 20 faces the magnetism-detecting device 10, the magnetic field generated by the coil 12 is strengthened (the magnetic field applied to the GMR elements 15 is strengthened) as compared with the case where the concave part 22 faces the magnetism-detecting device 10, resulting in an increased sensor output. In both the cases where the rotating body 20 is the soft magnetic body and where the body 20 has conductive performance, different levels of sensor outputs are obtained depending on whether the magnetism-detecting device 10 faces the convex part 21 or whether the device 10 faces the concave part 22, so that rotation states such as the rotational speed of the rotating body 20 can be detected. In case that the rotating body 20 is the soft magnetic body and also has conductive performance, there coexist an effect of relatively increasing the sensor output by the convex part 21 as the soft magnetic body strengthening the magnetic field applied to the GMR elements 15 and an effect of relatively decreasing the sensor output by the demagnetizing field from the convex part 21 having conductive performance, allowing greater one of the effects to strongly act on the relative magnitude of the sensor output.

As shown in FIG. 6, an output of the four full-bridge connected GMR elements 15 (a GMR element bridge) is amplified by a differential amplifier 17 such as an operational amplifier and is fed to an arithmetic processing unit (synchronous detection unit) 18. On the other hand, a signal applying unit 19 supplies a signal for generating an alternating magnetic field to the coil 12 and also inputs the signal to the arithmetic processing unit 18. The arithmetic processing unit 18 includes a multiplier, a low-pass filter and an amplifier, and synchronously detects an output signal from the differential amplifier 17 using the signal from the signal applying unit 19, for output as a sensor output to the exterior. A frequency Fs of the signal from the signal applying unit 19 is a frequency (FsFc) equal to or greater than a variation frequency Fc [Hz] of the facing distance between the rotating body 20 and the magnetism-detecting device 10, that is determined from the rotational speed of the rotating body 20 and from the arrangement pitch of the convex part 21 or the concave part 22 of the rotating body 20. Fs≥2×Fc is preferred, and a higher Fs can contribute to improvement in the detection accuracy as long as Fs lies within a range acceptable from characteristics of the elements of the magnetism-detecting device 10. In this case, Fc is expressed as Fc≥Ft×K where Ft [Hz] is a rotational speed of the rotating body 20 and K is the number of convexes 21 or the concaves 22 per circumference of the rotating body 20.

According to this embodiment, there can be presented the following effects.

(1) In the case where the rotating body 20 is made of a material having conductive performance, an eddy current occurs in the rotating body 20 by applying an alternating magnetic field to the rotating body 20, whereupon rotation detection of the rotating body 20 can be performed utilizing that a change in the magnitude (amplitude) of this eddy current due to rotation of the rotating body 20 brings about a change in the size of the demagnetizing field at the positions of the GMR elements 15. For this reason, the non-magnetic body which could not hitherto be an object for the rotation detection can also become an object for the rotation detection as long as it is made of one having conductive performance such as copper or aluminum. Also in the case where the rotating body 20 is a soft magnetic body, the rotation detection is feasible, resulting in an expanded range of materials of the rotating body 20 that can be a detection object.

(2) Since in the arithmetic processing unit 18 the output of the GMR element bridge is subjected to synchronous detection using a signal (signal for generation of an alternating magnetic field) from the signal applying unit 19, the output fluctuation arising from a disturbance magnetic field can be suppressed so that the rotation (movement) of the rotating body 20 can be detected at a high accuracy.

### Second Embodiment

Referring to FIG. 7, a second embodiment of the present invention will be described. The moving-body-detecting device 2 of this embodiment differs, as compared with that of the first embodiment, in that the rotating body 20 is replaced by a rotating body 30. The other details are the same. The rotating body 30 is in the shape of a disc or a regular polygonal plate and includes on its outer peripheral surface (outer periphery) a high-conductivity or high-magnetic-permeability portion 31 as a first portion and a low-conductivity or low-magnetic-permeability portion 32 as a second portion. In an example of this embodiment, the high-conductivity or high-magnetic-permeability portion 31 and the low-conductivity or low-magnetic-permeability portion 32 are alternately arranged at the same pitch on the outer peripheral surface of the rotating body 30 along the entire circumference thereof. A configuration example of the rotating body 30 can be one filling the concave part of a plastic teeth wheel with e.g. plating of metal such as copper or aluminum (the plastic part is the low-conductivity portion while the metal part is the high-conductivity portion) or one filling the concave part of a teeth wheel made of a non-magnetic material such as plastics or aluminum or the like with a soft magnetic material via permalloy plating or ferrite powder printing (the non-magnetic body part is the low-magnetic-permeability portion while the soft magnetic body part is the high-magnetic-permeability portion). The high-conductivity or high-magnetic-permeability portion 31 and the low-conductivity or low-magnetic-permeability portion 32 may have an uneven relationship.

The principle of rotation detection of the rotating body 30 in this embodiment is similar to that of the first embodiment. Specifically, the time when the high-conductivity or high-magnetic-permeability portion 31 of the rotating body 30 faces the magnetism-detecting device 10 corresponds to the time when the convex part 21 of the rotating body 20 faces the magnetism-detecting device 10 in the first embodiment. The time when the low-conductivity or low-magnetic-permeability portion 32 of the rotating body 30 faces the magnetism-detecting device 10 corresponds to the time when the concave part 22 of the rotating body 20 faces the magnetism-detecting device 10 in the first embodiment. This embodiment can also exhibit similar effects to those in the first embodiment. According to this embodiment, portions (a main body part) of the rotating body 30 other than the high-conductivity or high-magnetic-permeability portion 31 may be made of a non-magnetic material and insulator such as plastics or the like.

### Third Embodiment

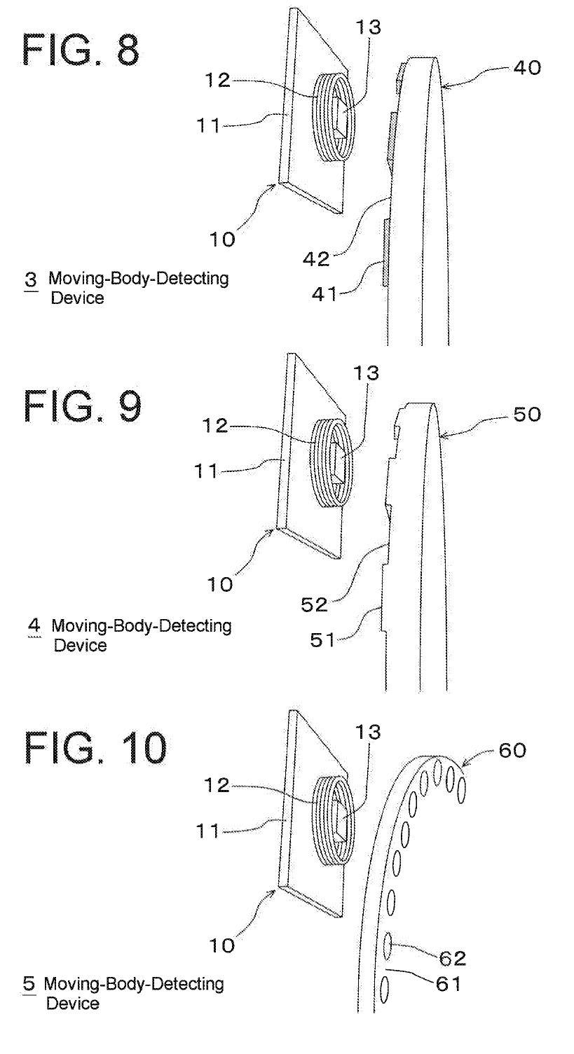

Referring to FIG. 8, a third embodiment of the present invention will be described. In a moving-body-detecting device 3 of this embodiment, dissimilar to that in the second embodiment, the magnetism-detecting device 10 is disposed at a position confronting with a non-center part, preferably, an outer peripheral edge vicinity part (outer peripheral part) of one side of a rotating body 40 in the axial direction thereof. The axial direction of the coil 12 is preferably parallel to the axial direction of the rotating body 40. The rotating body 40 includes, on the one side surface in the axial direction, a high-conductivity or high-magnetic-permeability portion 41 as a first portion and a low-conductivity or low-magnetic-permeability portion 42 as a second portion, at positions allowed by rotation of the body 40 to face the magnetism-detecting device 10. The high-conductivity or high-magnetic-permeability portion 41 and the low-conductivity or low-magnetic-permeability portion 42 are alternately arranged at the same pitch along the entire circumference thereof so as to make one round around the axis of the rotating body 40. Although the high-conductivity or high-magnetic-permeability portion 41 is disposed projecting toward the magnetism-detecting device 10 as compared with the low-conductivity or low-magnetic-permeability portion 42, it may be level with the low-conductivity or low-magnetic-permeability portion 42. The other details are the same as those in the second embodiment. This embodiment can also exhibit similar effects to those of the second embodiment.

### Fourth Embodiment

Referring to FIG. 9, a fourth embodiment of the present invention will be described. In a moving-body-detecting device 4 of this embodiment, dissimilar to that in the first embodiment, the magnetism-detecting device 10 is disposed at a position confronting a non-center part, preferably, an outer peripheral edge vicinity part (outer peripheral part) of a rotating body 50 on one side in the axial direction of the rotating body 50. The axial direction of the coil 12 is preferably parallel to the axial direction of the rotating body 50. The rotating body 50 includes, on the one side surface in the axial direction, a convex part 51 as a first portion and a concave part 52 as a second portion, at positions allowed by rotation of the body 50 to face the magnetism-detecting device 10. The convex part 51 and the concave part 52 are alternately arranged at the same pitch along the entire circumference thereof so as to make one round around the axis of the rotating body 50. The other details are the same as those in the first embodiment. This embodiment can also exhibit similar effects to those of the first embodiment.

### Fifth Embodiment

Referring to FIG. 10, a fifth embodiment of the present invention will be described. A moving-body-detecting device 5 of this embodiment differs from that of the fourth embodiment in that the concave part 52 is replaced by a through-hole 62 and in that the convex part 51 is replaced by a boundary part 61, with the other details being the same. A rotating body 60 includes, on one side surface in the axial direction, the through-hole 62 as a second portion at positions allowed by rotation of the body 60 to face the magnetism-detecting device 10. The through-hole 62 is disposed at the same pitch along the entire circumference thereof so as to make one round around the axis of the rotating body 60. The boundary part 61 between the adjacent through-holes 62 corresponds to a first portion. The principle of the rotation detection of the rotating body 60 in this embodiment is similar to that of the first embodiment. Specifically, the time when the boundary part 61 of the rotating body 60 faces the magnetism-detecting device 10 corresponds to the time when the convex part 21 of the rotating body 20 faces the magnetism-detecting device 10 in the first embodiment. The time when the through-hole 62 of the rotating body 60 faces the magnetism-detecting device 10 corresponds to the time when the concave part 22 of the rotating body 20 faces the magnetism-detecting device 10 in the first embodiment. This embodiment can also exhibit similar effects to those of the fourth embodiment.

### Sixth Embodiment

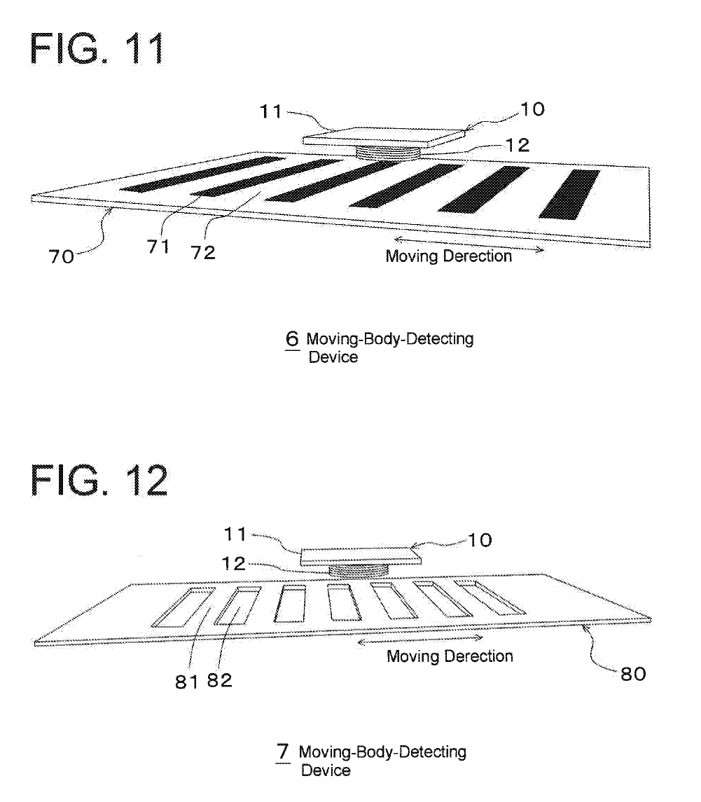

FIG. 11 is a schematic perspective view of a moving-body-detecting device 6 according to a sixth embodiment of the present invention. In the moving-body-detecting device 6 of this embodiment, the rotating body 30 of the second embodiment shown in FIG. 7 is replaced by a rectilinearly moving body 70, with the configuration of the magnetism-detecting device 10 being similar to that of the second embodiment. The rectilinearly moving body 70 is of a planar shape and includes, on a surface (hereinafter, referred to as “confronting surface”) confronting the magnetism-detecting device 10, a high-conductivity or high-magnetic-permeability portion 71 as a first portion and a low-conductivity or low-magnetic-permeability portion 72 as a second portion. In an example of this embodiment, the high-conductivity or high-magnetic-permeability portion 71 and the low-conductivity or low-magnetic-permeability portion 72 are alternately arranged at the same pitch on the confronting surface of rectilinearly moving body 70 along the direction of movement of the rectilinearly moving body 70. A configuration example of the rectilinearly moving body 70 can be one filling the concave part of a planar plastic plate with e.g. plating of metal such as copper or aluminum etc. (the plastic part is the low-conductivity portion while the metal part is the high-conductivity portion) or one filling the concave part of a planar plate of a non-magnetic material such as plastics or aluminum etc. with a soft magnetic material via permalloy plating or ferrite powder printing (the non-magnetic body part is the low-magnetic-permeability portion while the soft magnetic body part is the high-magnetic-permeability portion). The high-conductivity or high-magnetic-permeability portion 71 and the low-conductivity or low-magnetic-permeability portion 72 may have an uneven relationship. The principle of movement detection of the rectilinearly moving body 70 in this embodiment is similar to the principle of rotation detection in the second embodiment. This embodiment can also exhibit similar effects to those in the second embodiment.

### Seventh Embodiment

FIG. 12 is a schematic perspective view of a moving-body-detecting device 7 according to a seventh embodiment of the present invention. In the moving-body-detecting device 7 of this embodiment, the rotating body 60 of the fifth embodiment shown in FIG. 10 is replaced by a rectilinearly moving body 80, with the configuration of the magnetism-detecting device 10 being similar to that of the fifth embodiment. The rectilinearly moving body 80 includes, at positions allowed by its rotation to face the magnetism-detecting device 10, a through-hole 82 as a second portion. The through-holes 82 are arranged at the same pitch along the direction of movement of the rectilinearly moving body 80. A boundary part 81 between the adjacent through-holes 82 corresponds to a first part. The principle of movement detection of the rectilinearly moving body 80 in this embodiment is similar to the principle of rotation detection in the fifth embodiment. This embodiment can also exhibit similar effects to those in the fifth embodiment. In place of the through-hole 82, a recessed part (non-through-hole) may be disposed toward the magnetism-detecting device 10 so that similar effects can be presented.

Although the present invention has been described by way of the embodiments, it will be appreciated by those skilled in the art that the constituent parts or processing processes of the embodiments could variously be modified without departing from the scope defined in claims. Hereinafter, variants will be referred to.

Although in the embodiments the example has been described where the moving body (rotating body or rectilinearly moving body) moves (rotates) with the position of the magnetism-detecting device 10 being fixed, configuration may be such that the magnetism-detecting device 10 moves while the moving body remains stationary. That is, the movement of the moving body is a relative movement with respect to the magnetism-detecting device 10, and it does not matter whether the absolute position thereof moves. The moving body of the first to fifth embodiments may be a rectilinearly moving body such as a rack for example.

Although in the embodiments the configuration has been described where the facing distance between the magnetism-detecting device 10 and the moving body or the conductivity or magnetic permeability of a portion of the moving body confronting the magnetism-detecting device 10 takes alternately two levels of values different from each other depending on movement of the moving body, three or more levels of values may be taken in turn. The changes of parameters depending on movement of the moving body may be continuous. In the case of a moving body with sinusoidal irregularities, the facing distance from the magnetism-detecting device 10 varies continuously as a function of movement of the moving body.

Although in the embodiments the four GMR elements 15 are connected in full bridge, two GMR elements 15 may be connected in half bridge, or a signal GMR element 15 and a fixed resistor may be half-bridge connected. The magnetically sensitive element is not limited to the magnetoresistive effect element such as the GMR element and may be other types of elements such as a hall element or the like. In the case of the hall element, it may be disposed on a center axis of the coil 12 to obtain a required sensor output.

Although in the embodiments the soft magnetic body 16 is disposed to increase the sensor output, the soft magnetic body 16 may be excluded as long as a required level of sensor output is secured. At least one concave part or convex part of a moving body, or at least one high-conductivity or high-magnetic-permeability portion or low-conductivity or low-magnetic-permeability portion of a moving body would be enough, and the arrangement pitches in the case of disposing a plurality of features may be different from each other.

The magnetic field generating conductor is not limited to the coil but may be a rectilinear current path for example. The magnetic field generating means is not limited to the magnetic field generating conductor but may be a permanent magnet. Although the permanent magnet does not generate an alternating magnetic field, an eddy current occurs in a moving body with the movement of the moving body as long as the moving body has conductive performance. If the facing distance between the magnetism-detecting device 10 and the moving body, or the conductivity of a portion of the moving body confronting the magnetism-detecting device 10 varies with movement of the moving body, the magnitude of the eddy current also varies, making the detection of the moving body feasible.

### EXPLANATIONS OF LETTERS OR NUMERALS

7 moving-body-detecting device

10 magnetism-detecting device

11 substrate

12 coil (magnetic field generating conductor)

13 magnetic sensor

14 magnetically sensitive element chip

15 GMR element (magnetoresistive effect element)

16 soft magnetic body

17 differential amplifier

18 arithmetic processing unit (synchronous detection unit)

19 signal applying unit

20 rotating body (moving body)

21 convex part (first portion)

22 concave part (second portion)

30 rotating body

31 high-conductivity or high-magnetic-permeability portion (first portion)

32 low-conductivity or low-magnetic-permeability portion (second portion)

40 rotating body

41 high-conductivity or high-magnetic-permeability portion (first portion)

42 low-conductivity or low-magnetic-permeability portion (second portion)

50 rotating body (moving body)

51 convex part (first portion)

52 concave part (second portion)

60 rotating body (moving body)

61 boundary part (first portion)

62 through-hole (second portion)

70 rectilinearly moving body

71 high-conductivity or high-magnetic-permeability portion (first portion)

72 low-conductivity or low-magnetic-permeability portion (second portion)

80 rectilinearly moving body

81 boundary part (first portion)

82 through-hole (second portion)

1. A magnetism-detecting device that detects a magnetic field changed in response to relative movement of a moving body, comprising:
a magnetic field generating conductor;
a signal applying unit that supplies a signal for generating an alternating magnetic field to the magnetic field generating conductor; and
a magnetic sensor to which a magnetic field generated by the magnetic field generating conductor is applied.

2. The magnetism-detecting device according to claim 1, wherein the magnetic field generating conductor is a coil.

3. The magnetism-detecting device according to claim 1, comprising a synchronous detection unit that synchronously detects an output signal from the magnetic sensor using the signal supplied by the signal applying unit.

4. A moving-body-detecting device comprising:
a magnetism-detecting device; and
a moving body that moves with respect to the magnetism-detecting device, wherein the magnetism-detecting device comprises
a magnetic field generating conductor,
a signal applying unit that supplies a signal for generating an alternating magnetic field to the magnetic field generating conductor, and
a magnetic sensor to which a magnetic field generated by the magnetic field generating conductor is applied.

5. The moving-body-detecting device according to claim 4, wherein the moving body includes a first part and a second part, wherein each of the first part and the second part has a conductivity or magnetic permeability different from the other, so that the conductivity or magnetic permeability of a portion confronting the magnetism-detecting device varies with relative movement of the moving body.

6. The moving-body-detecting device according to claim 5, wherein frequency of the signal supplied by the signal applying unit is equal to or greater than a variation frequency of the conductivity or magnetic permeability of a portion of the moving body confronting the magnetism-detecting device.

7. The moving-body-detecting device according to claim 4, wherein the moving body includes at least one convex or concave part, so that distance from the magnetism-detecting device varies in accordance with relative movement of the moving body.

8. The moving-body-detecting device according to claim 7, wherein frequency of the signal supplied by the signal applying unit is equal to or greater than a variation frequency of the distance between the moving body and the magnetism-detecting device.

9. The moving-body-detecting device according to claims claim 4, wherein the magnetic field generating conductor is a coil circling around the magnetic sensor.

10. The moving-body-detecting device according to claim 4, wherein the magnetism-detecting device comprises a synchronous detection unit that synchronously detects an output signal from the magnetic sensor using the signal supplied by the signal applying unit.

11. A moving-body-detecting device comprising:
a magnetism-detecting device; and
a moving body that moves with respect to the magnetism-detecting device, wherein the magnetism-detecting device comprises
magnetic field generating means, and
a magnetic sensor to which a magnetic field generated by the magnetic field generating means is applied, wherein
an eddy current occurs in the moving body in response to relative movement of the moving body, and
the magnetic sensor detects a magnetic field change caused by a change of the eddy current.

12. The moving-body-detecting device according to claim 4, wherein the moving body is a rotating body and the moving body moves rotationally with respect to the magnetism-detecting device.

13. The moving-body-detecting device according to claim 4, wherein the moving body is a rectilinearly moving body and the moving body moves rectilinearly with respect to the magnetism-detecting device.

14. The moving-body-detecting device according to claim 11, wherein the moving body is a rotating body and the moving body moves rotationally with respect to the magnetism-detecting device.

15. The moving-body-detecting device according to claim 11, wherein the moving body is a rectilinearly moving body and the moving body moves rectilinearly with respect to the magnetism-detecting device.
